(19) United States
(12) Patent Application Publication
(10) Pub. No.: US 2006/0206926 A1
(43) Pub. Date: Sep. 14, 2006

(54) Single login systems and methods

(75) Inventors: Yongping Luo, Winnipeg (CA); Charles A. Cummins, Waterloo (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: AGFA INC.

(21) Appl. No.: 11/078,282

(22) Filed: Mar. 14, 2005

(51) Int. Cl. H04L 9/32

(52) U.S. Cl. 726/5

(57) ABSTRACT

The present invention relates to systems and methods of accessing secure applications from a portal using a single login procedure. More specifically, systems and methods are provided for allowing a client to access a secure application hosted on a server using a hyperlink provided on a secure portal. The hyperlink is associated with the secure application. According to one method, a client initiates a login procedure to gain access to the portal. Credentials are provided to the portal in response to a prompt for credentials. The credentials received from the client are authenticated and thereafter the client is granted access to the portal. To gain access to the secure application, the client actuates the hyperlink. A request containing the credentials is constructed and communicated to the server. The credentials contained within the request are authenticated and the client is granted access to the secure application. The secure application is presented to the client without requiring presentation of a separate login procedure for the secure application.

### FIELD OF THE INVENTION

This invention relates to systems and methods of accessing secure applications from a secure portal and more particularly to accessing such applications from a portal using a single login procedure.

### BACKGROUND OF THE INVENTION

Portals are frequently used on the Internet to provide a single location that provides access to a number of resources, such as hyperlinks and other information. Often a portal is dedicated to a particular topic, such as an Intranet for a particular company, or a more general topic such as “medical information”. These portals may be “secure”, in that proper credentials must be provided by a user in order to access the portal. These credentials are usually a ticket issued by a server or a combination user name and password that must be presented by a user, usually by using a login procedure.

The hyperlinks at the portal are typically used to allow the user to access web sites or documents and the like, and can be used to allow the user to access software applications. Such applications may be “secure” in that they also require the provision of credentials by the user. In such a case, the user typically has to present credentials for authentication twice, once on accessing the portal, and again on accessing the secure application.

The provision of credentials twice, particularly the same credentials twice, is a nuisance to users, who already likely have to deal with and memorize several combinations of user name/passwords to access various resources. The inefficiencies in the delay and cost in computing processing are also a problem.

One solution to the two login problem is disclosed in PCT Application No. PCT/US02/04844 to Weissman. Weissman discloses a system for communicating with servers using message definitions, in which a portal masks itself as a client to access a secure resource from the portal without re-entering the user's credentials.

Another solution is disclosed in U.S. Patent Application Publication No. 2004/0128506 to Blakely et al., which discloses a method and system for authentication in a heterogeneous federated environment, in which a trust proxy (and trust broker) is used to verify credentials when a request to access a secure domain is made.

While several solutions have been proposed, there remains a need for an efficient method and system that allows a client to access a secure application hosted on a server using a hyperlink provided on a secure portal.

### SUMMARY OF THE INVENTION

In a broad aspect of an embodiment of the present invention, a method is provided for allowing a client to access a secure application hosted on a server using a hyperlink provided on a secure portal. The hyperlink is associated with the secure application. The method includes: initiating a login procedure to gain access to the portal, which involves providing credentials to the portal in response to a prompt for credentials and authenticating the credentials received from the client; granting the client access to the portal; actuating the hyperlink to gain access to the secure application; constructing a request to the server containing the credentials; communicating the request to the server; authenticating the credentials contained within the request; and granting the client access to the secure application. In a further feature, granting the client access to the secure application includes presenting the secure application to the client without requiring presentation of a separate login procedure for the secure application. In another further feature, the credentials include the user name and password.

According to another broad aspect of an embodiment of the present invention, there is provided a method of allowing a client to access a secure application hosted on a server using a hyperlink provided on a secure portal. The hyperlink is associated with the secure application. The method includes: initiating a login procedure to gain access to the portal including providing credentials to the portal in response to a prompt for credentials and authenticating credentials received from the client; generating a ticket for the client using a ticket generator; granting the client access to the portal; actuating the hyperlink to gain access to the secure application; constructing a request to the server containing the ticket; communicating the request to the server; validating the ticket contained in the request; and granting the client access to the secure application if the ticket is valid. In a further feature, granting the client access to the secure application includes presenting the secure application to the client without requiring presentation of a separate login procedure for the secure application. In another further feature, the credentials include the user name and password.

In an additional feature, generating a ticket for the client using a ticket generator includes providing the ticket with a time stamp; and encrypting the ticket. In still another feature, validating the ticket contained in the request includes verifying that the ticket is properly encrypted and that the time stamp on the ticket is valid and has not expired.

In yet another additional feature, the method further includes presenting a separate login procedure for the secure application if the ticket is invalid.

In still an additional feature, the method includes generating a ticket for the client after authenticating the credentials in the request. The ticket includes a time stamp. The method further comprises including the ticket in a request for service for the secure application, communicating the request for service to the server and validating the ticket. Validating the ticket includes verifying that the ticket is properly encrypted and that the time stamp on the ticket is valid and has not expired. In a further feature, the method includes upon validation of the ticket, satisfying the request for service and issuing another ticket to replace the original ticket.

According to yet another aspect of an embodiment of the present invention, computer executable software code transmitted as an information signal, is provided for allowing a client to access a secure application hosted on a server using a hyperlink provided on a secure portal. The hyperlink being associated with the secure application. The code includes: (a) code to initiate a login procedure to gain access to the portal including code to provide credentials to the portal in response to a prompt for credentials and code to authenticate credentials received from the client; (b) code to grant the client access to the portal; (c) code to actuate the hyperlink to gain access to the secure application; (d) code to construct a request to the server containing the credentials; (e) code to communicate the request to the server; (f) code to authenticate the credentials contained in the request; and (g) code to grant the client access to the secure application.

According to a further aspect of an embodiment of the present invention, computer executable software code transmitted as an information signal, is provided for allowing a client to access a secure application hosted on a server using a hyperlink provided on a secure portal. The hyperlink is associated with the secure application. The code includes: (a) code to initiate a login procedure to gain access to the portal including code to provide credentials to the portal in response to a prompt for credentials and code to authenticate credentials received from the client; (b) code to grant the client access to the portal; (c) code to generate a ticket based on the credentials, for the client; (d) code to grant the client access to the portal; (e) code to actuate the hyperlink to gain access to the secure application; (f) code to construct a request containing the ticket; (g) code to communicate the request to the server; (h) code to validate the ticket contained in the request; and (i) code to grant the client access to the secure application if the ticket is valid.

According to still another broad aspect of an embodiment of the present invention, there is provided a computer readable medium carrying one or more sequences of instructions for allowing a client to access a secure application hosted on a server using a hyperlink provided on a secure portal. The hyperlink is associated with the secure application. The execution of the one or more sequences of instructions by one or more processors causes the one or more processors to perform the steps of: initiating a login procedure to gain access to the portal, including providing credentials to the portal in response to a prompt for credentials and authenticating the credentials received from the client; granting the client access to the portal; actuating the hyperlink to gain access to the secure application; constructing a request to the server containing the credentials; communicating the request to the server; authenticating the credentials contained within the request; and granting the client access to the secure application. The computer readable medium may further comprise a sequence of instructions for presenting the secure application to the client without requiring presentation of a separate login procedure for the secure application.

According to another aspect, there is provided a computer readable medium carrying one or more sequences of instructions for allowing a client to access a secure application hosted on a server using a hyperlink provided on a secure portal. The hyperlink is associated with the secure application. The execution of the one or more sequences of instructions by one or more processors causes the one or more processors to perform the steps of: initiating a login procedure to gain access to the portal including providing credentials to the portal in response to a prompt for credentials and authenticating credentials received from the client; generating a ticket for the client using a ticket generator; granting the client access to the portal; actuating the hyperlink to gain access to the secure application; constructing a request to the server containing the ticket; communicating the request to the server; validating the ticket contained in the request; and granting the client access to the secure application if the ticket is valid. The computer readable medium may further comprise a sequence of instructions for presenting the secure application to the client without requiring presentation of a separate login procedure for the secure application.

In still another aspect, there is provided a computer system for allowing a client to access a secure application hosted on a server using a hyperlink provided on a secure portal. The hyperlink is associated with the secure application. The computer system includes: means for initiating a logon procedure to gain access to the portal including means for providing credentials to the portal in response to a prompt for credentials and means for authenticating the credentials received from the client; means for granting the client access to the portal; means for actuating the hyperlink to gain access to the secure application; means for constructing a request to the server containing the credentials; means for communicating the request to the server; means for authenticating the credentials contained within the request; and means for granting the client access to the secure application. The computer system further including means for presenting the secure application to the client without requiring presentation of a separate login procedure for the secure application.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a block diagram showing a system according to an embodiment of the invention;

FIG. 2 is a block diagram showing a LAN based system according to another embodiment of the invention;

FIG. 3 is a block diagram of an alternative embodiment of a system according to the invention in which the secure application is on a different server than that of the portal;

FIG. 4 is a flow chart showing a method according to an embodiment of the invention in which a user name/password is used to access the secure application; and

FIG. 5 is a flow chart showing an alternative method according to a preferred embodiment of the invention in which a ticket is used to access the secure application.

### DETAILED DESCRIPTION OF EMBODIMENTS OF THE INVENTION

The description which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

Definitions

The words and phrases listed below as used throughout the specification in connection with the single login system described herein, will have the following meaning:

“secure application” means a software program accessible via a hyperlink, that generally requires authentication of credentials to access, or that has a number of security levels allowing clients with appropriate security level access to those portions of the software commensurate with the security level;

“credentials” means identification provided by a client that must be presented to access a resource, such as a portal or a secure application. Examples include a user name and password, a ticket or biometric identifiers such as voice prints, fingerprints, retinal scans or the like;

“portal” means a web site or software application that offers a broad array of resources and services for perusal or selection by a user, such as e-mail, forums, search engines, and hyperlinks to other resources, including software applications and web sites;

“servlet” means a small program that runs on a server that may run within a web server or web browser environment.

“request” means a HTTP request;

“server” means a computer in a network used to provide services, and may include software operating on such a computer;

“computer executable software code” means binary code executable by a computer to carry out a process or sequence of instructions;

“computer readable medium” means a storage medium in with software code may be stored and accessed by a computer. Such media includes RAM, ROM, hard drives, CDs, DVDs, and other volatile and non-volatile storage media;

“sequences of instructions” means one or more ordered instructions that can be carried out by a computer;

“information signal” means a signal by which a computer can communicate information to another computer. Information signals can be transmitted via conventional means, including ADSL, IDSN, T1 lines, WiFi and the like.

“login procedure” means the process by which a client computer operated by a user and seeking to gain access to an application or resource, is presented with a request for credentials and provides credentials to gain access to a resource;

“ticket generator” means a program designed to be executed by a computer, such as a client or server and that can be used to generate and validate a ticket.

The Hardware

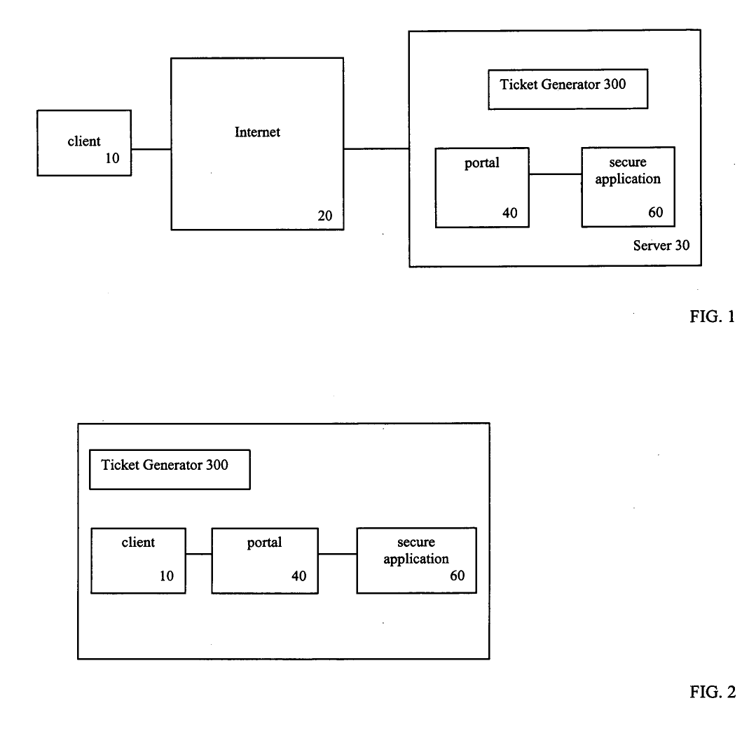

Sample configurations of systems to implement embodiments of the invention are seen in FIGS. 1 through 3. As seen in FIG. 1, a typical system according to a first embodiment of the invention is shown in which a client computer 10 accesses portal 40 via the Internet 20. In this embodiment, portal 40 operates on server 30.

Server 30 and client computer 10 are typically conventional computers. Such computers include communication means such as a modem, by which they can communicate information signals to other computers. These information signals include computer executable software code that can be executed by the recipient computer. These communications means allow the computers to receive, provide and communicate, requests, programs and credentials to other computers. The computers also typically have input means, such as a mouse, keyboard, microphone, fingerprint scanner or the like, and output means such as a monitor and speakers. The computers also have computer readable media, such as RAM and ROM, as well as hard drives and other storage media for carrying sequences of instructions. The computers are also provided with at least one processor by which they can carry out sequences of instructions, and can construct requests, permit access and authenticate credentials.

Client computer 10 can be another server, a personal computer (PC), or another device with sufficient computing power, such as a Blackberry® or a personal digital assistant (PDA). Client computer is in communication with the Internet 20 and thereby with portal 40 via conventional methods, including those described above.

The Internet 20 is the electronic communications network that connects computer networks and organizational computer facilities around the world, and includes the World Wide Web (WWW).

Server 30 is typically a computer or software application on a computer that is in communication with the Internet 20.

Portal 40 is typically a web page in HTML format accessible via the Internet 20. Alternatively, portal 40 may be a software application accessible via a local area network (LAN). Portal 40 typically has a collection of resources, such as hyperlinks to web sites (usually related sites), and has access to software applications and other information. Portal 40 is accessible by client computer 10 only after authentication of client's credentials.

Secure application 60 is a software application accessible via portal 40 only by provision of authenticated credentials from client 10.

A ticket generator 300 is also provided.

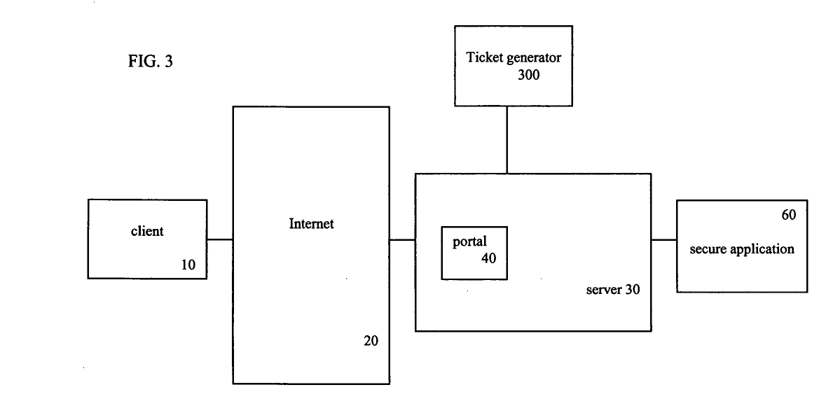

As seen in FIG. 1, in a first embodiment of the invention, secure application 60 may be operating on the same server 30 as portal 40, such that both the secure application and portal 40 may be accessed by client computer 10 via the Internet 20. In this embodiment, ticket generator 300 runs on server 30. In a second embodiment of the invention shown in FIG. 2, client computer 10, portal 40 and secure application 60 may all be part of a local area network (LAN) 70. In yet a third embodiment of the invention, as seen in FIG. 3, secure application 60 resides on a server other than server 30. In the latter embodiment, as illustrated, ticket generator 300 is running on a server distinct from server 30. Other possible configurations of systems to carry out embodiments of the invention will be known to those skilled in the art.

The Methods

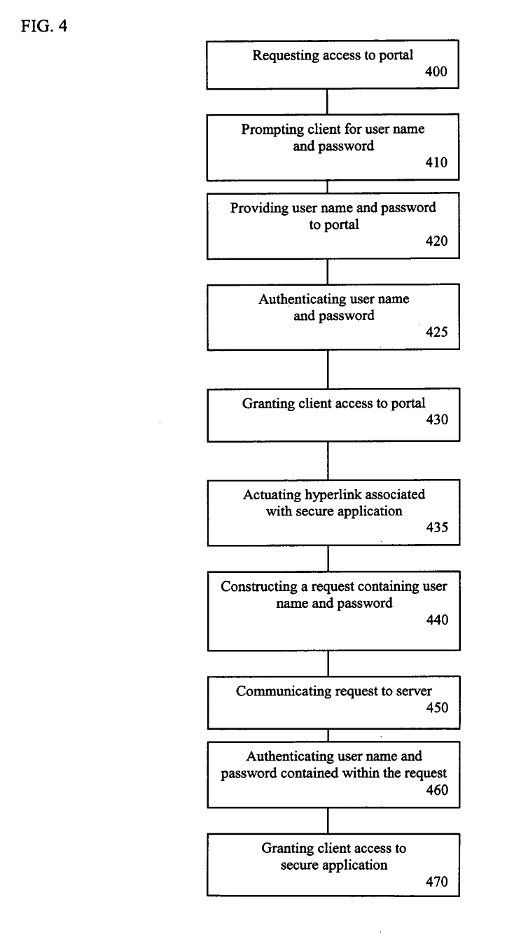

FIG. 4 illustrates a method according to an embodiment of the invention. The client 10 initiates a login procedure to gain access to the portal 40. More specifically, in step 400, client 10 requests access to portal 40. In step 410, portal 40 prompts client 10 to provide credentials, such as a user name and password. The client 10 provides the credentials (step 420). The portal 40 authenticates the credentials using conventional means (step 425) for instance, looking up the credentials in a dedicate database and ensuring that the user name corresponds to the password, and on authentication of the credentials, grants client 10 access to portal 40 (step 430).

The client 10 actuates the hyperlink associated with secure application 60 (step 435) and constructs a request to server 30 hosting the secure application 60 (step 440). In this embodiment, the request includes the user name and password previously provided to the portal to gain access thereto. While the request may be either a GET request or a POST request, it is preferable to employ a POST request for the sake of security. In contrast to a GET request, the POST request does not place the user name and password in the universal resources locator (URL) where it may be viewed or accessed by a person other than the user.

The request is communicated to the server 30 using conventional means (step 450). On receipt of the request, the server 30 authenticates the user name and password contained within the request (step 460). The client is then granted access to secure application 60 (step 470). More specifically, the secure application is presented to the client without requiring a separate, login procedure for the secure application. In the interest of maintaining security, preferably all of the above communications, particularly the request, are encrypted.

In some applications, it may be desirable to have ticket generator 300 generate a ticket with a time stamp, for the client after the server 30 has authenticated the user name and password. The ticket could be generated at a selected time interval, every five minutes, for instance, while the secure application is active. Such ticket could be forwarded to the client and could included in a subsequent request for service to the secure application (i.e. search query or the like). Upon receipt of this request, the ticket could be validated by the ticket generator by verifying that the ticket is encrypted with the appropriate private key and that the time stamp on the ticket is valid and has not expired. Thereafter, the secure application 60 would comply with the request for service and the ticket generator could be actuated to issue the client a new ticket having a more recent time stamp to replace the previously submitted ticket. In so long as the ticket remains valid and unexpired, the client continues to have access to the secure application. However, in the event that the secure application 60 remains inactive for a period exceeding the selected time interval, the time stamp on the ticket would expire, and the secure application would be timed out. If the client subsequently submitted a request to the secure application, the client would be presented with a login procedure for the secure application generally similar to the one used to gain access to the portal 40, wherein the client is prompted for a user name and password or the like.

In the foregoing embodiment, the credentials included a user name and password, however, it will be appreciated that this need not be the case in every application. In alternative embodiments, with appropriate modifications, the method could be implemented to similar advantage using credentials other than the user name and password pair. For instance, an alternate method could employ other identification means, for instance, biometric identifiers in the nature of voiceprints, fingerprints or retinal scans. Alternatively, the identification means could also take the form of a ticket.

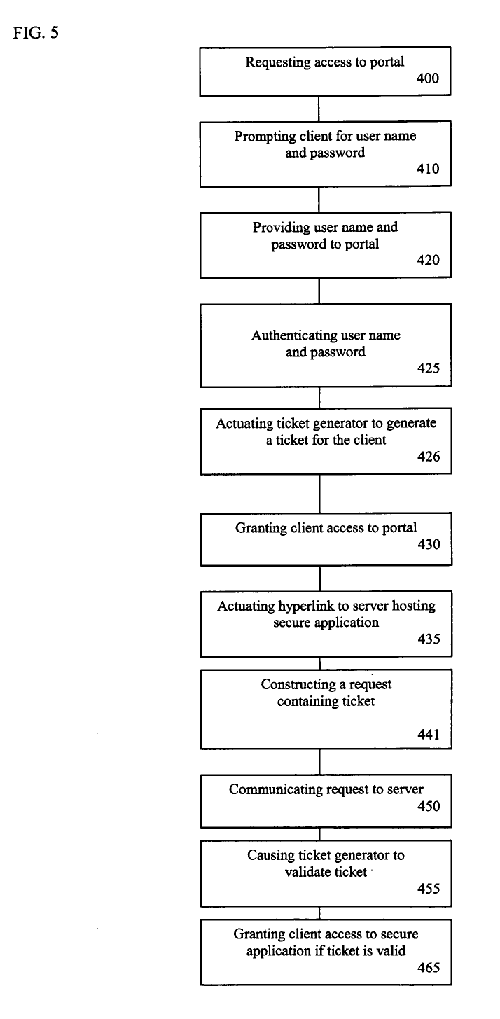

FIG. 5 shows a flow chart illustrating an alternative method according to a preferred embodiment of the invention. In like fashion to the method shown in FIG. 4, the client 10 initiates a login procedure to gain access to the portal 40. More specifically, in step 400, client 10 requests access to portal 40. In step 410, portal 40 prompts client 10 to provide credentials, such as a user name and password. The client 10 provides the credentials (step 420). The portal 40 authenticates the credentials using conventional means (step 425). Upon authentication of the credentials, the server 30 causes ticket generator 300 to generate a ticket for client 10 based on the user name and password (step 426). The client 10 is then granted access to the portal 40 (step 430).

In step 435, the client 10 actuates the hyperlink associated with secure application 60 and constructs a request to server 30 hosting the secure application 60 (step 441). However, in this embodiment, the request contains the previously generated ticket. In contrast to the method shown in FIG. 4, the user name and password are not directly contained within the request for improved security. While the request may be a POST request or a GET Request, use of a POST request is preferred because it ensures that the ticket will not be visible in the browser history.

The request is then communicated to server 30 (step 450). In step 455, the server 30 causes the ticket generator 300 to validate the ticket. Ticket validation involves verifying that the ticket is encrypted with the appropriate private key and that the time stamp on the ticket is valid and has not expired. If the ticket is still valid, the client is granted access to secure application 60 (step 465). The secure application is presented to the client without requiring a separate, user login procedure for the secure application.

In the event that the ticket is expired, client 10 is presented with a user login procedure for the secure application generally similar to the one used to gain access to the portal 40, wherein the client is prompted for a user name and password or the like. It will thus be understood that the time stamp on the ticket allows controlled access to secure application 60 by limiting the time within which such ticket is effective. For example, the ticket may only allow access for a period of five minutes from the time stamp on such ticket. The expiration period for the time stamp can be selected by the administrator of the server 30.

In this embodiment, the ticket generator 300 resides on the server 30, but this need not be the case in every embodiment. For example, in an alternative embodiment, ticket generator 300 may reside on an entirely different server.

The method according to the foregoing embodiment could also benefit from the general concept of periodically refreshing the ticket, described above in the context of the method shown in FIG. 4. More specifically, at a selected time interval, while the secure application is active, a ticket generator 300 may be actuated to generate a ticket with a time stamp, for the client. Such ticket could be forwarded to the client and could be included in a subsequent request for service to the secure application (i.e. search query or the like). Upon receipt of this request, the ticket could be validated by the ticket generator by verifying that the ticket is encrypted with the appropriate private key and that the time stamp on the ticket is valid and has not expired. Thereafter, the secure application 60 would comply with the request and a ticket generator could issue the client a new ticket with a more recent time stamp to replace the previously submitted, original ticket. Provided the ticket remained valid and unexpired, the client could continue to have access to the secure application. However, in the event the secure application 60 remained inactive for an extended period of time, the time stamp on the ticket would expire, and the secure application would be timed out. If the client subsequently submitted a request to the secure application, the client would be presented with a login procedure for the secure application generally similar to the one used to gain access to the portal 40, wherein the client is prompted for a user name and password or the like.

### EXAMPLE

In a more detailed description of an embodiment of the invention, portal 40 may provide access to a secure application 60 that has varying levels of access depending on the client 10. For example, if portal 40 represents an intranet for a particular hospital, then different clients 10 may have access to particular patient records, but not others. This would allow a doctor to access portal 40 by entering his or her user name and password. When the doctor clicks on the hyperlink to the patient records, secure application 60 is accessed, and the user name and password already provided by the client 60 is used to allow access to that doctor's patients only.

In such a case, the secure application 60 may be one of many applications hosted by the portal 40. A user operating a client 10 is required to type in their user name and password to access the portal 40. From a hyperlink within this portal 40, a user can access the secure application 60 (which may be a full applet client) without having to type in the user name and password again. This is because, when user clicks the link to the secure application 60 from the portal 40, the portal 40 will provide the already input user name and password (in the case of the method shown in FIG. 4) or a ticket (in the case of the method of FIG. 5) through the hyperlink, so that the user can access the secure application 60 directly without going through a login procedure.

With reference to the method shown in FIG. 4, when client 10 actuates a link to the secure application 60, an HTTP servlet request containing the user's user name and password is constructed. On authentication of the user name and password, the servlet on the secure application's server 30 responds to the request with a web page. The secure application 60 is then presented to client 10 so that it appears as though the client went through the normal login procedure. To maintain an acceptable level of security all communications are preferably made using HTTPS.

The example below is described with reference to the method shown in FIG. 5 using common http commands such as GET and POST that are known in the art.

The request to access the secure application 60 (to avoid the presentation of a login page) includes parameters for the user/password parameter pair and for the ticket parameter. For security reasons, the request should be a POST request or a GET request with a ticket parameter. A launch servlet launches the ExhibAppClass applet without showing the logon page (that is part of the normal login procedure). If the user and password parameter are used, ticket generator 300 generates a ticket for the client 10. The ticket passed in or generated is then put into the parameter list of the ExhibAppClass applet, with parameter name ticket. The width and height of the applet are preferably set to 0 so the user does not observe the applet. The other parameters of the ExhibAppClass applet are similar to that of a normal launch servlet. As a result, the options that can be attached to a general launch request can also be attached to a single logon request. For example, the request can set the parameter “-SSL-ENABLED” for security level.

On the client, the ExhibAppClass applet transmitted from the server, looks for the ticket parameter. If the ticket parameter exists, the applet will skip the login page, and use the ticket to logon to the server.

The following further details this embodiment of the invention, in which a ticket is issued to the client by the ticket generator 300 and included in the request thereafter transmitted to server 30.

Module: Jexhib-Launcher

A servlet, named SingleLogonLauncher, is introduced to generate an html page that contains the ExhibAppClass applet, the applet that launches the EXHIBIT application (i.e. the first page of secure application 60) on the client. The servlet generates the html page according to an html template. Because the servlet and the ExhibitLauncher servlet generate the html pages in a similar way, it is efficient to use the same logic for both servlets. The logic for generating the html is in class GenericLauncher, the super class of ExhibitLauncher. Preferably SingleLogonLauncher extends GenericLauncher.

Preferably, the major extensions of class SingleLogonLauncher to class GenericLauncher are:

1. SingleLogonLauncher needs to handle POST requests.

2. SingleLogonLaucher accepts GET request with ticket parameter.

3. SingleLogonLauncher provides a ticket parameter to the ExhibAppClass applet.

4. SingleLogonLauncher set the width and height of the applet to 0.

Module: Exhibit-Client

On the client side, the ExhibAppClass applet must check the ticket parameter. If the ticket parameter is available, then the applet will not launch the logon page. Instead, it launches the application window directly. This application window is functional in a typical browser used to open an HTML file. To operate the single logon using the POST command the userid and password is entered from the browser.

Although particular preferred embodiments of the invention have been disclosed in detail for illustrative purposes, it will be recognized that variations or modifications of the disclosed systems and methods lie within the scope of the present invention.

What is claimed is:

1. A method of allowing a client to access a secure application hosted on a server using a hyperlink provided on a secure portal, the hyperlink being associated with the secure application, the method comprising:
initiating a login procedure to gain access to the portal including providing credentials to the portal in response to a prompt for credentials and authenticating credentials received from the client;
granting the client access to the portal;
actuating the hyperlink to gain access to the secure application;
constructing a request containing the credentials;
communicating the request to the server;
authenticating the credentials contained in the request; and
granting the client access to the secure application.

2. The method of claim 1 wherein granting the client access to the secure application includes presenting the secure application to the client without requiring presentation of a separate login procedure for the secure application.

3. The method of claim 2 wherein the credentials include a user name and password.

4. The method of claim 3 wherein the request is encrypted.

5. The method of claim 2 further comprising generating a ticket for the client after authenticating the credentials in the request, the ticket including a time stamp.

6. The method of claim 5 further comprising including the ticket in a request for service for the secure application and communicating the request for service to the server.

7. The method of claim 6 further comprising validating the ticket.

8. The method of claim 7 wherein validating the ticket includes verifying that the ticket is properly encrypted and that the time stamp on the ticket is valid and has not expired.

9. The method of claim 8 further comprising upon validation of the ticket, satisfying the request for service and issuing another ticket to replace the original ticket.

10. A method of allowing a client to access a secure application hosted on a server using a hyperlink provided on a secure portal, the hyperlink being associated with the secure application, the method comprising:
initiating a login procedure to gain access to the portal including providing credentials to the portal in response to a prompt for credentials and authenticating credentials received from the client;
generating a ticket based on the user name and password, for the client using a ticket generator;
granting the client access to the portal;
actuating the hyperlink to gain access to the secure application;
constructing a request containing the ticket;
communicating the request to the server;
validating the ticket contained in the request; and
granting the client access to the secure application if the ticket is valid.

11. The method of claim 10 wherein granting the client access to the secure application includes presenting the secure application to the client without requiring presentation of a separate login procedure for the secure application.

12. The method of claim 11 wherein generating a ticket for the client using a ticket generator includes providing the ticket with a time stamp and encrypting the ticket.

13. The method of claim 12 wherein validating the ticket contained in the request includes verifying that the ticket is properly encrypted and that the time stamp on the ticket is valid and has not expired.

14. The method of claim 13 further including presenting a separate login procedure for the secure application if the ticket is invalid.

15. The method of claim 10 wherein the credentials include a user name and password.

16. Computer executable software code transmitted as an information signal, for allowing a client to access a secure application hosted on a server using a hyperlink provided on a secure portal, the hyperlink being associated with the secure application, the code comprising:
(a) code to initiate a login procedure to gain access to the portal including code to provide credentials to the portal in response to a prompt for credentials and code to authenticate credentials received from the client;
(b) code to grant the client access to the portal;
(c) code to actuate the hyperlink to gain access to the secure application;
(d) code to construct a request to the server containing the credentials;
(e) code to communicate the request to the server;
(f) code to authenticate the credentials contained in the request; and
(g) code to grant the client access to the secure application.

17. Computer executable software code transmitted as an information signal, for allowing a client to access a secure application hosted on a server using a hyperlink provided on a secure portal, the hyperlink being associated with the secure application, the code comprising:
(a) code to initiate a login procedure to gain access to the portal including code to provide credentials to the portal in response to a prompt for credentials and code to authenticate credentials received from the client;
(b) code to grant the client access to the portal;
(c) code to generate a ticket based on the credentials, for the client;
(d) code to grant the client access to the portal;
(e) code to actuate the hyperlink to gain access to the secure application;
(f) code to construct a request containing the ticket;
(g) code to communicate the request to the server;
(h) code to validate the ticket contained in the request; and
(i) code to grant the client access to the secure application if the ticket is valid.
